(19) United States
(12) Patent Application Publication
(10) Pub. No.: US 2016/0098480 A1
(43) Pub. Date: Apr. 7, 2016

(54) AUTHOR MODERATED SENTIMENT CLASSIFICATION METHOD AND SYSTEM

(71) Applicant: Xerox Corporation, Norwalk, CT (US)

(72) Inventor: Scott Peter Nowson, Grenoble (FR)

(21) Appl. No.: 14/503,789

(22) Filed: Oct. 1, 2014

(51) Int. Cl. G06F 17/30; G06N 99/00

(52) U.S. Cl. CPC G06F 17/30705; G06F 17/30684; G06N 99/005

(57) ABSTRACT

This disclosure provides a method, system and computer program product for classifying text according to one of a plurality of sentiments. According to an exemplary method, text is classified using two or more sentiment classifiers which are tuned to distinct author profile traits and the resulting scores are combined using a normalized weighted function to produce a final resulting classification score.

### BACKGROUND

This disclosure, and the exemplary embodiments described herein relate to text analytics including sentiment mining and author profiling. Specifically, this disclosure provides a text analytic method, system and computer program product which uses author profiling as an input to a sentiment mining process.

Opinion mining or affective language processing focuses on analyzing subjective features of text or speech, such as sentiment, opinion, emotion or point of view.

Within computational linguistics, much work in the past has focused on sentiment and opinion mining related to specific entities or events, where binary classifications are generated for a mined opinion, i.e., a positive or negative rating. For instance, Pang et al. (2002) considered the thumbs up/thumbs down decision, where a film review is determined to be positive or negative. However, Pang and Lee (2005) point out that ranking items or comparing reviews benefits from finer-grained classifications, over multiple ordered classes, e.g., determining if a film review is two- or three- or four-star.

Despite this move toward finer grained classification, the majority of research today—and indeed most commercially available systems add only a single middle case to the original binary classification task, i.e., expressing a text as positive, negative, or neutral.

Discussing affective computing in general, Picard (1997) notes that phenomena vary in duration, ranging from short-lived feelings, through emotions, to moods, and ultimately to long-lived, slowly-changing personality characteristics. This increase in stability parallels a shift between the traditionally text-focused nature of sentiment analysis, to the human level analytics of author profiling.

Broadly speaking, author profiling is the application of techniques from text analytics in order to determine some property of an author of a text(s). These properties may include, but are not limited to, demographics such as age, gender, nationality, location, language nativeness, and psychometric characteristics as mentioned by Picard (1997). This author-centric approach is referred to as Personal Language Analytics (PLA).

Oberlander and Nowson (2006) argued that on-going work on sentiment analysis or opinion-mining stands to benefit from progress on personality classification and PLA more broadly. The reason is that people vary in their personality characteristics, and they vary in how they appraise events, i.e., how strongly they phrase their praise or condemnation. Reiter and Sripada (2004) suggest that lexical choice may sometimes be determined by a writer's idiolect—their personal language preferences. Oberlander and Nowson (2006) suggest that while idiolect can be a matter of accident or experience, it may also reflect systematic, personality/demographic-based differences. For example, it has been shown in multiple linguistic studies that females are generally more emotionally expressive then men.

This can help explain why, as Pang and Lee noted, one person's four star review is another's two-star. To put it more bluntly, if you're not a very outgoing sort of person, then your thumbs up might be mistaken for someone else's thumbs down.

This disclosure provides author moderated sentiment analytics which uses the output of an author profiling process or prior knowledge of an author's traits in order to select a number of targeted sentiment classifier models before combining an output of the specific sentiment classifier models into a single sentiment score on a linear scale.

### INCORPORATION BY REFERENCE

Haeng-Jin Jang, Jaemoon Sim, Yonnim Lee, and Ohbyung Kwon (2013), “Deep sentiment analysis: Mining the causality between personality-value-attitude for analyzing business ads in social media”, Expert Systems with Applications 40 (18);
Jon Oberlander and Scott Nowson (2006), “Whose thumb is it anyway?”, Classifying author personality from weblog text, In Proceedings of CoLing/ACL 2006, Sydney, Australia;
Bo Pang, Lillian Lee, and Shivakumar Vaithyanathan (2002), “Thumbs up? Sentiment classification using machine learning techniques”, In Proceedings of the 2002 Conference on Empirical Methods in Natural Language Processing (EMNLP);
Bo Pang and Lillian Lee (2005), “Seeing stars: Exploiting class relationships for sentiment categorization with respect to rating scales”, In Proceedings of the 43rd Annual Meeting of the ACL;
James W. Pennebaker, Cindy K. Chung, Molly Ireland, Amy Gonzales, Roger J. Booth (2007), “The development and psychometric properties of Iiwc2007; The University of Texas at Austin, LIWCNET 1: 1-22;
Rosalind W. Picard (1997), “Affective Computing”, MIT Press, Cambridge, Mass.;
Ehud Reiter and Somayajulu Sripada (2004), “Contextual influences on near-synonym choice”, In Proceedings of the Third International Conference on Natural Language Generation;
S. Craig Roberts, Antonios Vakirtzis, Lilja Kristjánsdöttir and Jan Havli\check{c}ek (2013), “Who Punishes? Personality Traits Predict Individual Variation in Punitive Sentiment”, Evolutionary Psychology 11(1); and
H. Andrew Schwartz, Johannes C. Eichstaedt, Margaret L. Kern, Lukasz Dziurzynski, Stephanie M. Ramones, Megha Agrawal, Achal Shah, Michal Kosinski, David Stillwell, Martin E. P. Seligman, and Lyle H. Ungar (2013), “Personality, Gender, and Age in the Language of Social Media: The Open-Vocabulary Approach”, PLoS ONE 8(9), are incorporated herein by reference in their entirety.

### BRIEF DESCRIPTION

In one embodiment of this disclosure, described is a method of performing sentiment classification of text associated with an opinion of an author of the text related to a subject, the method comprising: a) receiving a textual representation of an opinion of an author of the textual representation related to a subject; b) receiving an author profile including one or more traits associated with the author; c) extracting a linguistic feature from the textual representation of the opinion of the author; d) processing the extracted linguistic feature with two or more sentiment classifiers, the two or more sentiment classifiers each tuned to a distinct author profile trait, and the two or more sentiment classifiers generating respective sentiment classification scores based on the extracted linguistic features; and e) processing the respective sentiment classification scores to generate a single resulting sentiment classification score associated with the textual representation of the opinion of the author.

In another embodiment of this disclosure, described is a sentiment classification system comprising: a processor and associated memory configured to receive a textual representation of an opinion of an author of the textual representation related to a subject, the processor and associated memory configured to execute instructions to perform a method of sentiment classification of text associated with an opinion of an author of the text related to a subject, the method comprising: a) receiving a textual representation of an opinion of an author of the textual representation related to a subject; b) receiving an author profile including one or more traits associated with the author; c) extracting a linguistic feature from the textual representation of the opinion of the author; d) processing the extracted linguistic feature with two or more sentiment classifiers, the two or more sentiment classifiers each tuned to a distinct author profile trait, and the two or more sentiment classifiers generating respective sentiment classification scores based on the extracted linguistic features; and e) processing the respective sentiment classification scores to generate a single resulting sentiment classification score associated with the textual representation of the opinion of the author.

In still another embodiment of this disclosure, described is a computer program product comprising: a non-transitory computer-usable data carrier storing instructions that, when executed by a computer, cause the computer to perform a method of performing sentiment classification of text associated with an opinion of an author of the text related to a subject method comprising: a) receiving a textual representation of an opinion of an author of the textual representation related to a subject; b) receiving an author profile including one or more traits associated with the author; c) extracting a linguistic feature from the textual representation of the opinion of the author; d) processing the extracted linguistic feature with two or more sentiment classifiers, the two or more sentiment classifiers each tuned to a distinct author profile trait, and the two or more sentiment classifiers generating respective sentiment classification scores based on the extracted linguistic features; and e) processing the respective sentiment classification scores to generate a single resulting sentiment classification score associated with the textual representation of the opinion of the author.

### BRIEF DESCRIPTION OF THE DRAWINGS

FIG. 1 is a flow chart of an exemplary embodiment of an author trait moderated sentiment classification method according to this disclosure.

FIG. 2 is a simplified example of a review.

FIG. 3 is a flow chart of another exemplary embodiment of an author trait moderated sentiment classification method according to this disclosure.

FIG. 4 shows a hypothetical distribution of identical opinion corpus over a course 3-class distribution and a finer-grained 5-class distribution.

FIG. 5 shows hypothetical sentiment distributions for populations of gender=male, gender=female and neuroticism=high.

FIG. 6 is a flow chart of an exemplary embodiment of a method of training a sentiment classifier according to this disclosure.

FIG. 7 is a flow chart of an exemplary embodiment of a method of using the trained sentiment classifier shown in FIG. 6 to classify the sentiment of authors of text according to this disclosure.

FIG. 8 is a block diagram of an exemplary embodiment of a system for performing an author trait moderated sentiment classification method according to this disclosure.

### DETAILED DESCRIPTION

A “text element,” as used herein, can comprise a word or group of words which together form a part of a generally longer text string, such as a sentence, in a natural language, such as English or French. In the case of ideographic languages, such as Japanese or Chinese, text elements may comprise one or more ideographic characters.

This disclosure provides a method and system to combine opinion mining and author profiling in order to build an improved and finer-grain opinion mining system, i.e., a sentiment classification system. According to an exemplary embodiment, the output of author profiling is used to select more specific sentiment classifiers that are combined into a single sentiment score, ranging from −1 to +1. Linguistic features are extracted from the text and provide inputs to a series of sentiment classifiers, each sentiment classifier tuned to a single user, i.e., author, trait, such as age, gender, etc., the output scores of the sentiment classifier is then combined using a normalized weighted sum to produce a single final result.

As discussed in the background, individual differences—such as our age, gender, or personality traits—play a large part in how humans express themselves differently from one another. It has been shown that these traits are projected in linguistic variation. However, the science of automatically understanding our expression of opinions—sentiment analysis—takes a broad approach that assumes opinions are expressed in the same way. Provided herein is a sentiment classification approach which uses knowledge of individual differences to inform a more personalized—and thus more accurate—sentiment model. By understanding more about an author expressing sentiment in a text prior to performing a sentiment classification of the text, a relatively more robust sentiment classification can be provided and a more fine-grained sentiment can be reported.

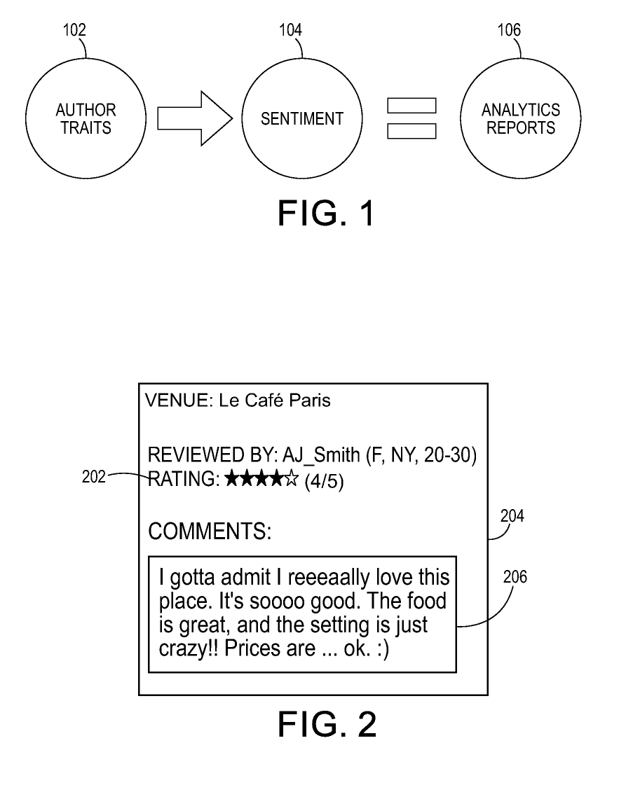

With reference to FIG. 1, shown is an exemplary embodiment of a method of performing sentiment classification of text associated with an opinion of an author, for example a review as shown in FIG. 2.

Determine author traits 102, either automatically or through prior knowledge. Using the author traits determined 102, determine sentiment classification models 104 and generate analytics report(s) 106 based on the determined sentiment classification models.

As illustrated in FIG. 2, each review 204 in the corpus generally includes a rating 202 of an item being reviewed, such as a product or service, and an author's textual entry 206, in which the author provides one or more comments about the item, for example a printer model. The author can be any person generating a review, such as a customer, a user of a product or service, or the like.

The exact format of the reviews 204 may depend on the source. For example, independent review websites, such as epinions.com®, fnac.com®, rottentomatoes.com®, and urbanspoon.com®, differ in structure. In general, however, reviewers are asked to put a global rating 202 associated with their written comments 206. Comments 206 are written in a natural language, such as English or French, and may include one or more sentences. The rating 202 can be a score, e.g., number of stars, a percentage, a ratio, or a selected one of a finite set of textual ratings, such as “good,” “average,” and “poor” or a yes/no answer to a question about the item, or the like, from which a discrete value can be obtained. For example, on some review websites, people rank products on a scale from 1 to 5 stars, 1 star synthesizing a very bad (negative) opinion, and 5 stars a very good (positive) one. On other review websites, a global rating such as 4/5, 9/10, is given. Ratings on a scale which may include both positive and negative values are also within the scope of sentiment classification methods and systems according to this disclosure, for example, with +1 being the most positive and −1 being the most negative rating.

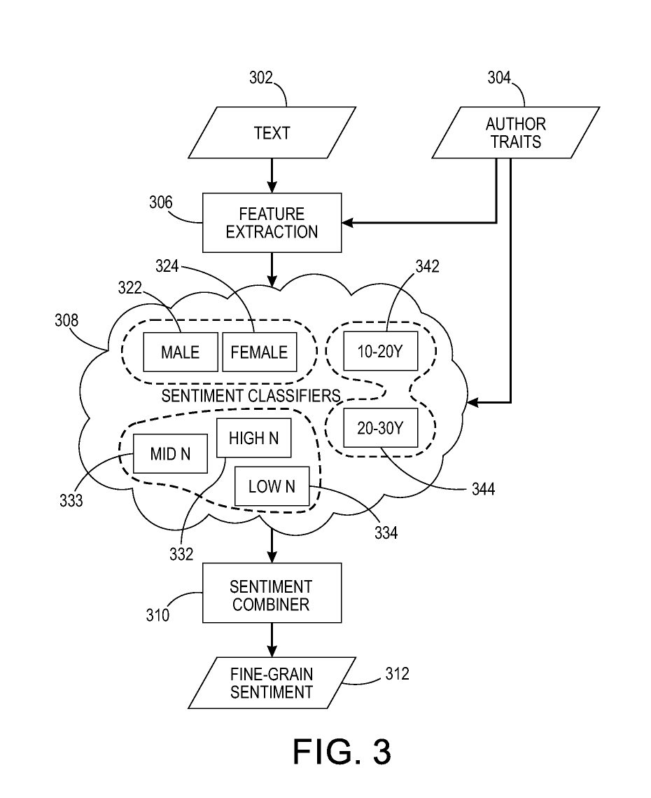

With reference to FIG. 3, shown is a flow chart of another exemplary embodiment of an author trait moderated sentiment classification method according to this disclosure.

At a high level, the disclosed method and system include a text classification software implemented algorithm which provides a relatively finer grain classification of author sentiment in the following manner:

Initially, a feature extraction process receives as input a text 302 and a set of author traits 304. Traits 304 may be known in advance, or determined by author profiling.

Next, the feature extraction process 306 extracts relevant linguistic features from the received text 302.

Next, the extracted linguistic features are provided to a series of sentiment classifiers 308, each tuned to a single trait=class pairing, e.g., Gender=Male 322 and Age=20-30 344.

The scores produced by these classifiers are combined by a sentiment combiner 310 using a normalized weighted sum to produce a numeric sentiment fine-grain score between −1 and 1 312.

Various aspects of the method and system are now described in greater detail below.

Input Text Data 302 and Author Traits 304.

The method computes sentiment for a single textual unit, one at a time. This can include any kind of text, for example, a social media posting such as a Tweet® or Facebook® status update.

In addition to the text data, the method also requires demographic and psychometric traits of the author of the text, according to an exemplary embodiment of this disclosure. These traits may include, but are not limited to, demographics such as age, gender, level of education, nationality, location, and language nativeness, and psychometric values such as, but not limited to, personality traits drawn from the Big 5 model: Neuroticism, Extraversion, Openness to Experience, Agreeableness, and Conscientiousness. For example, a low N (Neuroticism) classifier 334, mid N classifier 333, and high N classifier 332.

The author traits provided can be provided by an automated author profiling system or from prior knowledge of the author.

Feature Extraction 306.

At this stage, knowing which trait-informed sentiment models will be used provides a basis to determine which features are to be extracted from the inputted text for calculation. Since a more complex, multi-model approach to sentiment analysis is used, features sets can be optimized. By reducing linguistic variation due to author traits, models with smaller feature sets can be used.

In addition to a typical open vocabulary “bag-of-words” approach, other features can be employed such as:
A priori dictionary-based feature extractor, such as the Linguistic Inquiry and Word Count tool, see LIWC; Pennebaker et al., 2007, which provides a carefully constructed and psychologically validated set of categories based on over 20 years of human research;
Grammatical data feature extractor, such as n-grams of POS tags and parser output; and
Trait specific sentiment models.

Actual sentiment classification is done in a “cloud” of trait=class trained specific models. For an author of a known or deduced profile, the method uses one sentiment classifier per trait, where the classifiers are trained using sentiment annotated texts from authors for whom demographic and/or psychometric traits are known.

Each classifier uses a subset of the extracted feature set, optimized in order to produce a sentiment class for the input text, one of {negative, neutral, positive}. This coarse grained level is used for two reasons:
1) The majority of available sentiment annotated data uses a coarse grained system; and
2) It allows for data sparsity that may occur by dividing the population into various classes.

A finer grained level of sentiment analysis is achieved by the sentiment combiner 310, as described below.

Should the trait input be derived from an automatic means, it may be that a trait class is determined with a relatively low confidence. In this instance, if there are enough other trait models to use, the classifier associated with low confidence can be ignored. Alternatively, a fall back approach of selecting all models for that trait can be used.

Sentiment Combiner 310.

The final stage is the combination of the output of the various classifiers into a single integer value. For example, the single integer value S being a normalized weighted sum over all classifiers calculated as follows:

$$S = \frac{{\sum }_{i = 1}^{t} {w}_{i} {s}_{i}}{{\sum }_{i = 1}^{t} {w}_{i}}$$

where:
t is the number of traits;
sᵢε{−1, 0, 1} (mapped from {negative, neutral, positive}); and
wᵢ is the weight associated with trait i sentiment classification.

The weight of a classification decision can be related to the confidence of the classifier for the specific output or input in the case of automatically derived traits, whereby wᵢ must be greater than a threshold value.

Alternatively, a weight can be assigned to a trait generally in the context of a task.

Rather than a classification output, S is an integer, for example, −1.0≦S≦1.0. Depending on the application, S can be mapped into a set of classes for reporting, e.g. negative, mild negative, neutral, mild positive, positive.

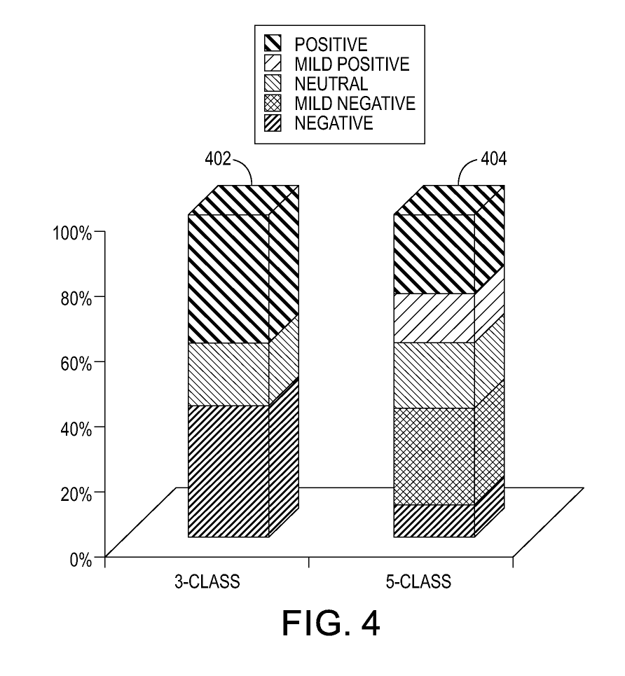

According to an exemplary embodiment of a method for performing sentiment classification of a text, a fine grained measurement of sentiment of the user is reported as a result. For instance, a population analytical level can look like a move from reporting in a 3-class style 402 to a 5-class style 404 as shown in FIG. 4. In this instance shown in FIG. 4, the introduction of finer grained categories reveals that the balance of opinion is not as it had appeared in the 3-class style 402, but is weighted more positively.

With regard to personalized sentiment analysis, the more human traits included for consideration, the better a sentiment model is able to be trained specifically for a single individual. For example, a small footprint collection of trait specific sentiment models selected based on a user's own profile, which can be deployed in a health care environment, e.g., automatically diagnosing from health records, etc., changes in an individual's mood, or as a component of an automated personal assistant, e.g., by inputting implicit information about an individual's experience, such as a hotel stay, the disclosed sentiment analytics recognizes explicitly the degree to which the individual enjoyed the hotel stay.

With regard to personalized recommendation systems, a commercial goal of many companies, including on-line retailers, is how to best recommend products to their customers. A number of common approaches include “people who like item A, which you like, also like item B” and “people you know like item C.” By understanding more about an individual and how they express their opinions, a sentiment analytic method and system can provide a product recommendation style indicating “people like you like item D.”

As discussed above, sentiment can be considered a (temporally) localized phenomenon—a single tweet, for instance, is treated as a standalone expression of sentiment which is measured. Author traits are more stable over time, therefore it may be beneficial to collect additional texts for each author in a sentiment corpus, e.g., 20-50 more tweets. This allows the sentiment analytics to generalize beyond the immediate sentiment providing a more accurate classification using more text/words. In other words, this approach can be used in a commercially deployed system designed to profile a customer where multiple texts from an author/customer are used to classify the sentiment of a single authored text.

There has been much previous work exploring relationships between human traits, e.g., demographic and psychometric, and language choice, Schwartz et al. (2013).

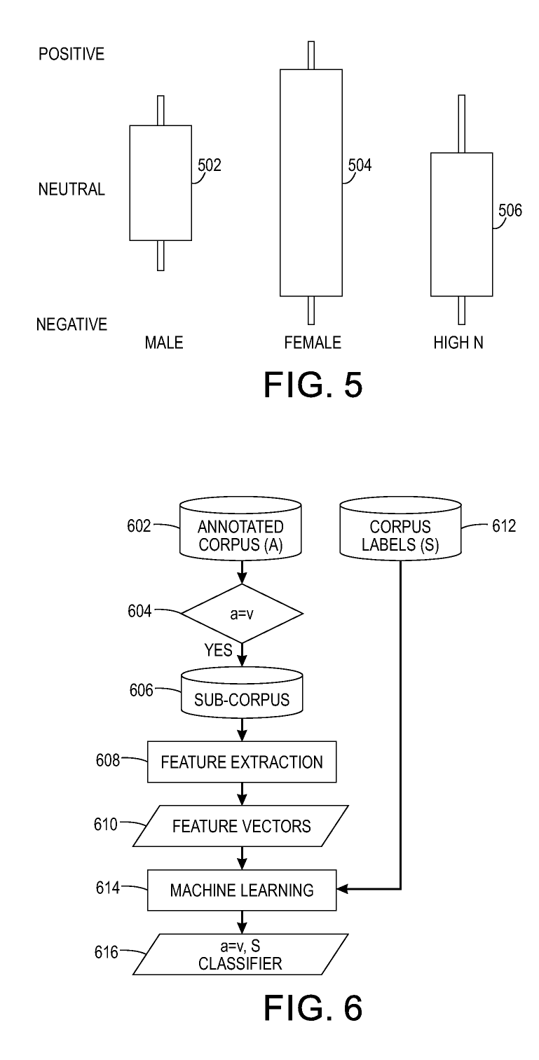

As previously discussed, it has been shown that females generally use more emotionally rich language than men. In other words, on a score scale of 1-5, men use language which maps to scores between 2 and 4, while women generally score between 1 and 5, as shown in FIG. 5.

Similarly, a high score 506 on the trait of Neuroticism correlates significantly with the use of words relating to negative emotions, which can be manifested as an emotional expression distribution skewed toward the negative, as shown in FIG. 5.

According to an exemplary embodiment of the sentiment analytics provided herein, male 502 and female 504 authored texts are considered separately. This allows the normalization embodiment of the sentiment analytics provided herein to make a finer grained distinction around a neutral value. By making this distinction, a more accurate classification of male sentiment results as it is generally more subtle. In addition, extremes of male sentiment can be proportionally further from a norm relative to an identical sentiment expressed by a female.

Notably, a more fine-grained approach to sentiment also lends itself better to studies of sentiment over time. This is particularly that case when the focus could be on monitoring the relationship between a single individual and brand over time.

With reference to FIG. 6, shown is a flow chart of an exemplary embodiment of a method of training a sentiment classifier according to this disclosure.

### Input:

A corpus of text 602, annotated for author (A)ttributes, where each A has a set of (V)alues 604.
Associated (S)entiment labels 612.

### Process:

Initially, for each Attribute A, place document with annotation a=v into a sub-corpus 606, for each Value V.
Then, for each document, extract [e.g., Linguistic, statistical] features 608 to create feature vector 610.
Next, a machine learning algorithm operates on feature vectors 610 to learn S for each document 614, based on the feature vectors 610 calculated and corpus labels (s) provided.

### Output:

A single classifier which predicts S values given an input document with Attribute a=Value v 616.

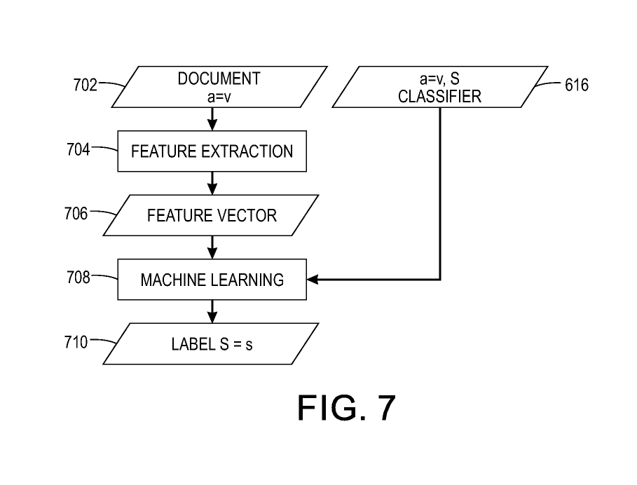

With reference to FIG. 7, shown is a flow chart of an exemplary embodiment of a method of using the trained sentiment classifier shown in FIG. 6 to classify the sentiment of authors of text according to this disclosure.

### Input:

A single document text 702, annotated for author Attribute a=Value v.
A single classifier 616 which predicts S values for documents with Attribute a=Value v.

### Process:

Extract 704 [e.g., Linguistic, statistical] features to create feature vector 706.
Machine learning algorithm applies a=v classifier to feature vectors 704 to predict S 708.

### Output:

A predicted label for document S of value s 710.

Using confidence thresholding for the selection of models, as described above can reduce the impact of potential errors from automatically predicted traits as inputs to selecting sentiment models.

Sentiment models are tuned to smaller feature set and therefore can reduce relative computational requirements of a system.

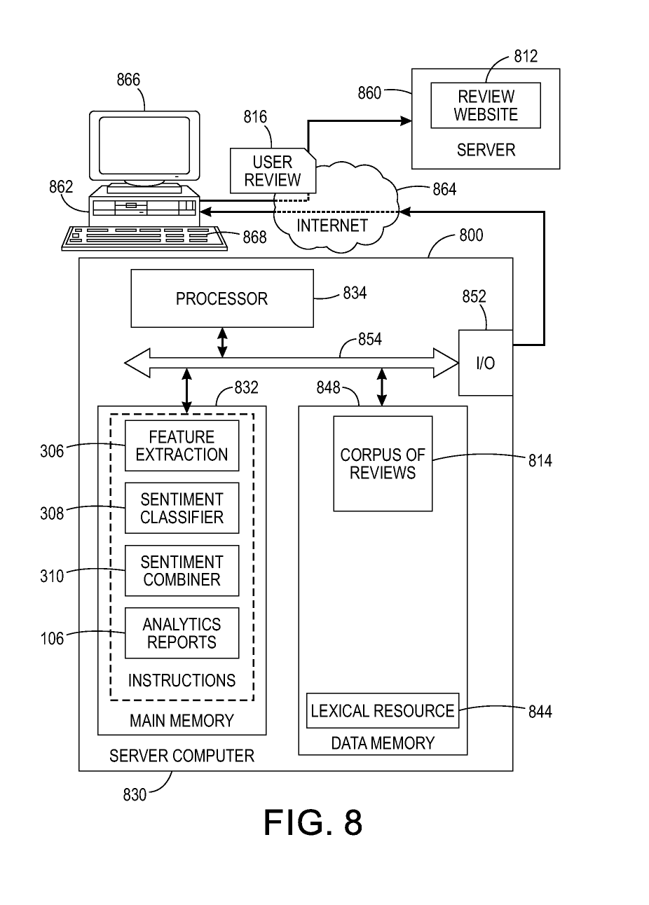

With reference to FIG. 8, an exemplary system 800 for performing sentiment classification is shown. The system includes a source 812 of a corpus 814 of structured user reviews 816.

The system 800 includes one or more computing device(s), such as the illustrated server computer 830. The computer includes main memory 832, which stores instructions for performing the exemplary methods disclosed herein, which are implemented by a processor 834. In particular, memory 832 stores a feature extraction module 306 processing the text content 206 of the reviews, a sentiment classifier module 308 classifying the sentiment of the author of the text 206, and a sentiment combiner to generate a final sentiment score 310. One or more lexical resources 844 may also be provided to process the text, i.e., review, for classification. Instructions may also include an Analytics Reports component 106, which generates one or more analytics reports associated with the sentiment classification of a plurality of reviews processed. Components 306, 308, 310, and 106 may be separate or combined and may be in the form of hardware or, as illustrated, in a combination of hardware and software.

A network interface 852 allows the system 800 to communicate with external devices. Components 832, 834, 848, 852 of the system may communicate via a data/control bus 854.

The exemplary system 800 is shown as being located on a server computer 830 which is communicatively connected with a remote server 860 which hosts the review website 812 and/or with a remote client computing device 862, such as a PC, laptop, tablet computer, smartphone, or the like. However, it is to be appreciated that the system 800 may be physically located on any of the computing devices and/or may be distributed over two or more computing devices. The various computers 830, 860, 862 may be similarly configured in terms of hardware, e.g., with a processor and memory as for computer 830, and may communicate via wired or wireless links 864, such as a local area network or a wide area network, such as the Internet. For example, an author accesses the website 812 with a web browser on the client device 862 and uses a user input device, such as a keyboard 868, keypad, touch screen, or the like, to input a review, to the web site 812. During input, the review is displayed to the user on a display device 866, such as a computer monitor or LCD screen, associated with the computer 862. Once the user is satisfied with the review, the user can submit it to the review website 812. The review website can be mined by the system 800 for collecting many such reviews to form the corpus 814.

The memory 832, 848 may represent any type of tangible computer readable medium such as random access memory (RAM), read only memory (ROM), magnetic disk or tape, optical disk, flash memory, or holographic memory. In one embodiment, the memory 832, 848 comprises a combination of random access memory and read only memory. In some embodiments, the processor 834 and memory 832 and/or 848 may be combined in a single chip. The network interface 852 may comprise a modulator/demodulator (MODEM).

The digital processor 834 can be variously embodied, such as by a single-core processor, a dual-core processor (or more generally by a multiple-core processor), a digital processor and cooperating math coprocessor, a digital controller, or the like. The digital processor 834, in addition to controlling the operation of the computer 830, executes instructions stored in memory 832 for performing the method outlined in FIGS. 1, 3, 6, and 7.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A method of performing sentiment classification of text associated with an opinion of an author of the text related to a subject, the method comprising:
a) receiving a textual representation of an opinion of an author of the textual representation related to a subject;
b) receiving an author profile including one or more traits associated with the author;
c) extracting a linguistic feature from the textual representation of the opinion of the author;
d) processing the extracted linguistic feature with two or more sentiment classifiers, the two or more sentiment classifiers each tuned to a distinct author profile trait, and the two or more sentiment classifiers generating respective sentiment classification scores based on the extracted linguistic features; and
e) processing the respective sentiment classification scores to generate a single resulting sentiment classification score associated with the textual representation of the opinion of the author.

2. The method of performing sentiment classification of text according to claim 1, wherein the author profile includes one or more of demographic and psychometric traits.

3. The method of performing sentiment classification of text according to claim 1, wherein the author profile is generated from one of an automated author profiling process, a manual author profiling process and a prior knowledge author profile database.

4. The method of performing sentiment classification of text according to claim 1, wherein the linguistic feature extracted from the textual representation is based on the author profile.

5. The method of performing sentiment classification of text according to claim 1, wherein the linguistic feature is based on one or more of a bag-of-words, a priori dictionary, and grammatical data.

6. The method of performing sentiment classification of text according to claim 1, wherein the two or more sentiment classifiers includes a cloud of trait=class trained specific models.

7. The method of performing sentiment classification of text according to claim 1, wherein step d) uses one or more sentiment classifiers per trait.

8. The method of performing sentiment classification of text according to claim 1, wherein the two or more sentiment classifiers are trained using sentiment annotated training texts from authors with known demographic and/or psychometric traits.

9. The method of performing sentiment classification of text according to claim 1, wherein
step c) extracts a linguistic feature set from the textual representation of the opinion of the author, the linguistic feature set including a plurality of linguistic features associated with a plurality of potential author profile traits; and
step d) processes the extracted linguistic feature set using a plurality of sentiment classifiers, each classifier classifying a subset of the extracted feature set, the subset associated with a trait included in the received author profile.

10. The method of performing sentiment classification of text according to claim 1, wherein the single resulting sentiment classification score is a normalized weighted sum of the sentiment classification scores generated in step d).

11. A sentiment classification system comprising:
a processor and associated memory configured to receive a textual representation of an opinion of an author of the textual representation related to a subject, the processor and associated memory configured to execute instructions to perform a method of sentiment classification of text associated with an opinion of an author of the text related to a subject, the method comprising:
a) receiving a textual representation of an opinion of an author of the textual representation related to a subject;
b) receiving an author profile including one or more traits associated with the author;
c) extracting a linguistic feature from the textual representation of the opinion of the author;
d) processing the extracted linguistic feature with two or more sentiment classifiers, the two or more sentiment classifiers each tuned to a distinct author profile trait, and the two or more sentiment classifiers generating respective sentiment classification scores based on the extracted linguistic features; and
e) processing the respective sentiment classification scores to generate a single resulting sentiment classification score associated with the textual representation of the opinion of the author.

12. The sentiment classification system according to claim 11, wherein the author profile includes one or more of demographic and psychometric traits.

13. The sentiment classification system according to claim 11, wherein the author profile is generated from one of an automated author profiling process, a manual author profiling process and a prior knowledge author profile database.

14. The sentiment classification system according to claim 11, wherein the linguistic feature extracted from the textual representation is based on the author profile.

15. The sentiment classification system according to claim 11, the linguistic feature is based on one or more of a bag-of-words, a priori dictionary, and grammatical data.

16. The sentiment classification system according to claim 11, wherein the two or more sentiment classifiers includes a cloud of trait=class trained specific models.

17. The sentiment classification system according to claim 11, wherein step d) uses one or more sentiment classifiers per trait.

18. The sentiment classification system according to claim 11, wherein the two or more sentiment classifiers are trained using sentiment annotated training texts from authors with known demographic and/or psychometric traits.

19. The sentiment classification system according to claim 11, wherein
step c) extracts a linguistic feature set from the textual representation of the opinion of the author, the linguistic feature set including a plurality of linguistic features associated with a plurality of potential author profile traits; and
step d) processes the extracted linguistic feature set using a plurality of sentiment classifiers, each classifier classifying a subset of the extracted feature set, the subset associated with a trait included in the received author profile.

20. The sentiment classification system according to claim 11, wherein the single resulting sentiment classification score is a normalized weighted sum of the sentiment classification scores generated in step d).

21. A computer program product comprising:
a non-transitory computer-usable data carrier storing instructions that, when executed by a computer, cause the computer to perform a method of performing sentiment classification of text associated with an opinion of an author of the text related to a subject method comprising:
a) receiving a textual representation of an opinion of an author of the textual representation related to a subject;
b) receiving an author profile including one or more traits associated with the author;
c) extracting a linguistic feature from the textual representation of the opinion of the author;
d) processing the extracted linguistic feature with two or more sentiment classifiers, the two or more sentiment classifiers each tuned to a distinct author profile trait, and the two or more sentiment classifiers generating respective sentiment classification scores based on the extracted linguistic features; and
e) processing the respective sentiment classification scores to generate a single resulting sentiment classification score associated with the textual representation of the opinion of the author.

22. The computer program product according to claim 21, wherein the linguistic feature extracted from the textual representation is based on the author profile.

23. The computer program product according to claim 21, wherein the two or more sentiment classifiers are trained using sentiment annotated training texts from authors with known demographic and/or psychometric traits.

24. The computer program product according to claim 21, wherein
step c) extracts a linguistic feature set from the textual representation of the opinion of the author, the linguistic feature set including a plurality of linguistic features associated with a plurality of potential author profile traits; and
step d) processes the extracted linguistic feature set using a plurality of sentiment classifiers, each classifier classifying a subset of the extracted feature set, the subset associated with a trait included in the received author profile.
